(19) United States
(12) Patent Application Publication
(10) Pub. No.: US 2024/0070459 A1
(43) Pub. Date: Feb. 29, 2024

(54) TRAINING MACHINE LEARNING MODELS WITH SPARSE INPUT

(71) Applicant: X Development LLC, Mountain View, CA (US)

(72) Inventors: Artem Goncharuk, Mountain View, CA (US); Robert Clapp, Sunnyvale, CA (US); Kevin Forsythe Smith, Pleasanton, CA (US); Shiang Yong Looi, San Jose, CA (US); Ananya Gupta, San Francisco, CA (US); Joses Bolutife Omojola, Baton Rouge, LA (US); Min Jun Park, Mountain View, CA (US)

(21) Appl. No.: 18/456,792

(22) Filed: Aug. 28, 2023

Related U.S. Application Data
(60) Provisional application No. 63/401,963, filed on Aug. 29, 2022.

(51) Int. Cl. G06N 3/08; G06N 5/04

(52) U.S. Cl. CPC G06N 3/08; G06N 5/04

(57) ABSTRACT

This disclosure describes a system and method for effectively training a machine learning model to identify features in DAS and/or seismic imaging data with limited or no human labels. This is accomplished using a masked autoencoder (MAE) network that is trained in multiple stages. The first stage is a self-supervised learning (SSL) stage where the model is generically trained to predict data that has been removed (masked) from an original dataset. The second stage involves performing additional predictive training on a second dataset that is specific to a particular geographic region, or specific to a certain set of desired features. The model is fine-tuned using labeled data in order to develop feature extraction capabilities.

### CROSS-REFERENCE TO RELATED APPLICATION

This application claims priority under 35 U.S.C. § 119 to U.S. Provisional Patent Application Ser. No. 63/401,963, filed on Aug. 29, 2022, the entire contents of which are incorporated by reference herein.

### TECHNICAL BACKGROUND

This disclosure generally relates to training machine learning models to identify subsurface features with sparse training datasets.

### BACKGROUND

Machine learning has resulted in breakthrough improvements in automation and classification in various fields. Successful training of a machine learning algorithm often depends on large datasets that include labels in order to permit evaluation of the algorithm's performance. In certain environments there is a significant amount of data, but human labeling is not feasible, accurate, or effective. In these environments, a means for training machine learning models to perform feature extraction without large, labeled datasets is necessary.

### SUMMARY

In general, the disclosure involves systems and methods for training a machine learning model, including performing self-supervised learning on a first dataset to initially train the machine learning model, performing region specific training on the initially trained machine learning model using a second dataset, and refining the machine learning model using a third dataset to train the machine learning model to perform a particular inference task.

Implementations can optionally include one or more of the following features.

In some instances, the first dataset includes unlabeled data.

In some instances, the second dataset is associated with a particular geographic region.

In some instances, the third dataset includes labeled data.

In some instances, the third dataset includes synthetic data.

In some instances, the third dataset is less than ten percent the size of the first dataset.

In some instances, synthetic data is generated using a physics based simulation, and the synthetic data is generated to mimic real world regional data.

In some instances, the particular inference task includes wave picking to identify at least one of: a geographic fault, a geographic layer, P-wave arrival, S-wave arrival, or a location of a subsurface feature or event.

In some instances, the first, second, and third datasets are distributed acoustic sensing (DAS) datasets.

In some instances, the first, second, and third datasets are seismic imaging datasets.

In some instances, the first dataset includes synthetic data.

In some instances, the machine learning model is a masked autoencoder network. In some instances, the masked autoencoder network is configured to receive two dimensional input data, the two dimensions including time and channel. In some instances, the masked autoencoder network is configured to receive three dimensional input, the three dimensions including time, channel, and frequency. In some instances the input data is three dimensional (time, x-position, and y-position) or (depth, x-position, and y-position). In some instances, the input data is 4-dimensional adding a frequency or wavenumber axis to the above.

In some instances, the training data to the masked autoencoder network is masked in rectangles or cuboids.

In some instances, refining the machine learning model using the third dataset includes performing supervised learning training methods to learn feature extraction on the third dataset.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

This disclosure relates to training a machine learning model in a label sparse environment.

FIG. 1 is an example system architecture for using machine learning to identify subsurface features.

FIG. 2 is a block diagram of an example computing system for feature identification of data.

FIG. 3 is a flowchart describing an example method for training a machine learning algorithm.

FIG. 4 is a schematic diagram of a computer system for performing operations according to the present disclosure.

### DETAILED DESCRIPTION

This disclosure describes a system and method for training a machine learning model to perform feature identification or event identification on datasets with sparse labeling. Multiple methods of generating data relating to the subsurface have been developed, including geophysical or seismic imaging techniques such as ground penetrating radar, induced polarization, seismic tomography, reflection seismology, refraction seismology, electrical resistivity tomography, and others which produce seismic images of the subsurface. Additionally alternative sensing techniques are available, such as distributed acoustic sensing (DAS) which uses an interrogator in a fiber optic cable to develop high resolution strain data in the cable at acoustic frequencies. DAS results in relatively low cost, high fidelity, passive or active sensing over broad areas, and can use existing infrastructure (e.g., communications fiber optics in urban areas) to provide significant quantities of data from which insights can be drawn. In some implementations, DAS can replace conventional seismic recorders such as geophones in both surface and downhole environments. In some implementations DAS augments conventional seismic sensors.

Both DAS and seismic imaging produce large quantities of data, but are difficult to label, and human labeling often introduces bias and error. Further, because DAS data and seismic images can vary significantly from reading to reading, even for the same region in similar conditions, it has traditionally been difficult to train machine learning models to classify features of the subsurface based on the data. This disclosure describes a system and method for effectively training a machine learning model to identify features in DAS and/or seismic imaging data with limited or no human labels. This is accomplished using a masked autoencoder (MAE) network that is trained in multiple stages. The first stage is a self-supervised learning (SSL) stage where the model is generically trained to predict data that has been removed (masked) from an original dataset. The second stage involves performing additional predictive training on a second dataset that is specific to a particular geographic region, or specific to a certain set of desired features. This additional predictive training can include further unsupervised or SSL learning of the MAE, as well as involve tuning only a subset of the layers for the base machine learning model. In some implementations, the second data set is predicted upon following completion of training. Finally, the model is fine tuned using labeled data in order to develop feature extraction capabilities. Because the model was previously trained using SSL, relatively little labeled data is required. Further, synthetic data generated by a simulation or other algorithm can provide an automatically labeled dataset, reducing or even removing the need for human labeled data entirely.

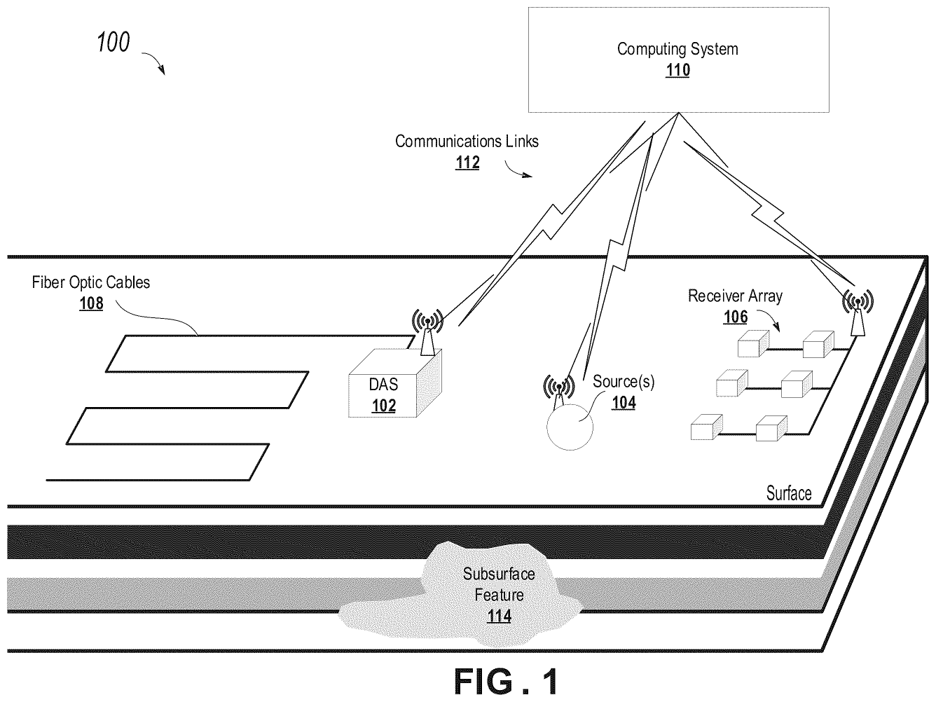

FIG. 1 is an example system architecture for using machine learning to identify subsurface features. System 100 includes a plurality of data collection systems, such as a DAS system 102, one or more sources 104, and a receiver array 106. These data collection systems collect raw, or unprocessed, data associated with the subsurface, and in some cases, one or more subsurface features 114, and transmit the data via one or more communication links 122 to a computing system 110 for processing.

The DAS system 102 uses one or more fiber optic cables 108 to perform sensing of the geologic region. In some instances, the DAS system 102 has dedicated fiber optic cables 108 that are positioned in a specific geometry and configured to enhance seismic sensing. These fiber optic cables 108 can be arranged on the surface, or in a downhole configuration. DAS system 102 can detect seismic energy, temperature sensing, and strain in the fiber optic cable. In some implementations, the DAS system 102 can utilize preexisting fiber optic cables (e.g., fiber optic internet networks) in order to perform sensing. In general the DAS system 102 is capable of high sample rate sensing of acoustic vibrations, with accurate localization. For example, the DAS system 102 can provide strain data at a 20-2000 Hz sample rate over a distance of 50 km or greater, with 1 m or less spatial resolution. In some implementations, DAS system 102 performs certain preprocessing or edge processing of the raw data prior to transmitting it to the computing system 110. For example, DAS system 102 can perform band pass filtering, frequency domain conversion, normalization, noise filtering, or other processes to the raw data. In some implementations, the DAS system 102 provides two dimensional data to the computing system, including strain or energy data in a time dimension and a channel dimension (or spatial dimension). In some implementations, DAS system 102 provides three dimensional data (e.g., time, channel, and frequency). In some implementations, the DAS data is augmented with frequency data from one or more separate sensors, prior to being transmitted to the computing system 110.

One or more sources 104 can be included in the system and can be configured to transmit known signals or waveforms into the subsurface. Sources 104 can be percussive, or explosive sources, and can communicate with the DAS system 102, the receiver array 106, or the computing system 110 in order to coordinate operations. In some implementations, sources 104 are active sources, and are triggered by a central control system (e.g., computing system 110 or other controller) and transmit waves at a predetermined frequency and energy. In some implementations, sources 104 do not communicate, and are separate entities from system 100 that create a known or unknown noise signal. For example, wells or drilling operations can be used as a source 104 by computing system 110. In another example, natural seismic activity or ambient noise could be used as a source 104 by computing system 110. In general, sources 104 transmit energy into or throughout the subsurface, including reflecting off and transmitting through one or more subsurface features 114 which can be layers, faults, trapped liquids or gasses, or other geologic features.

A receiver array 106 can record seismic data and can include vibrometers, seismometers, accelerometers, or other devices. In some implementations the receiver array 106 is a dedicated seismic array, and each receiver is positioned in order to permit beamforming and high resolution subsurface wave detection. In some implementations, the receiver array 106 can be an array of disparate, unique sensors that serve additional purposes. For example, an accelerometer on a radio antenna, or a seismometer that has a primary function of earthquake detection can be used as a part of receiver array 106. In some implementations receiver array 106 commands or otherwise communicates with one or more sources 104, and produces seismic images associated with the subsurface. Seismic imaging can include, but is not limited to ground penetrating radar, induced polarization, seismic tomography, reflection seismology, and electrical resistivity tomography produced by geophones, MEMs accelerometers, seismometers, vibrometers or other sensors.

The data collection systems can communicate with the computing system 110 via one or more communications links 112. The communication links 112 can be, but are not limited to, a wired communication interface (e.g., USB, Ethernet, fiber optic) or wireless communication interface (e.g., Bluetooth, ZigBee, WiFi, infrared (IR), CDMA2000, etc.). The communication links 112 can be used to communicate directly or indirectly, e.g., through a network, with the computing system 110.

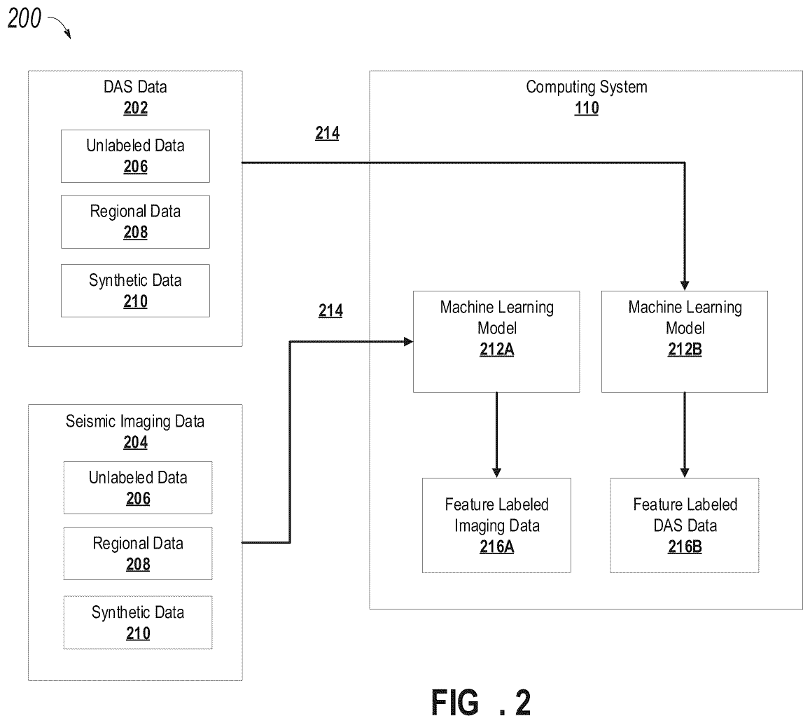

The computing system 110 receives raw, or pre-processed data from the data collection systems in FIG. 1, and performs one or more inferences, resulting in feature identification and the measurement or recording of one or more parameters associated with the subsurface. Pre-processed data can include normalized data, filtered data, de-noised data, or data that has otherwise been conditioned for ingestion by one or more machine learning models. For example, computing system 110 can receive DAS data from DAS system 102, and seismic images from receiver array 106, and may be able to infer a size, location, density, and/or composition of subsurface feature 114 as well as one or more seismic events that might occur. Computing system 110 includes one or more machine learning models, which are described in further detail below with respect to FIGS. 2-4.

FIG. 2 is a block diagram of an example computing system 200 for generating subsurface inferences based on received data. The computing system 110 can receive data from various systems (e.g., the receiver array 106 of FIG. 1) via a communications link 214. The communication link 214 can be but is not limited to a wired communication interface (e.g., USB, Ethernet, fiber optic) or wireless communication interface (e.g., Bluetooth, ZigBee, WiFi, infrared (IR), CDMA2000, etc.). The communication link 214 can be used to communicate directly or indirectly, e.g., through a network, with the computing system 110.

The computing system 110 receives DAS data 202 and Seismic imaging data 204 from various sources via the communications link 214. DAS data 202 and seismic imaging data 204 can be raw data (e.g., traces), or processed data.

Both DAS data 202 and seismic imaging data 204 include unlabeled data 206. Unlabeled data 206 can come from various data collection systems, or be historically collected/stored data. Unlabeled data 206 can represent data from many regions and systems (e.g., multiple different DAS arrays or receiver arrays) and can include raw data, pre-processed data, or a mixture thereof. In some implementations the unlabeled data 206 is provided from one or more remote databases, and represents the bulk of the data upon which the machine learning models 212A and 212B will be trained.

Regional data 208 can be both DAS data 202 and seismic imaging data 204 and can include data that is specific to a particular geographic region, or has particular properties that are specific to a certain implementation of the machine learning models 212A or 212B. In some implementations regional data 208 is collected for a particular region of interest over a period of time and used during a second training phase of the machine learning models 212A and 212B to refine their algorithms for a specific region, set of sensors, or set of geologic properties. In some implementations, the regional data 208 can include a subset of human labeled data, which can be used during a final stage of training for the machine learning models to train on feature extraction or wave picking.

Synthetic data 210 can be computer generated data that includes automatically created (e.g., computer generated) labels. Synthetic data can be generated using physics based models. For example, an artificial region including one or more features to be extracted by the machine learning model 212A or 212B can be generated. Then a simulated DAS survey, or simulated nodal survey can be generated by running a wave propagation physics model simulating both one or more sources (including noise) and receivers (e.g., DAS, or geophones) with receiver induced noise to produce simulated or synthetic data. Similarly, for the artificial region, a velocity model for that region can be convolved with a wavelet, and wave propagation can be simulated throughout the region with a full waveform inversion process performed to generate seismic image data. Because the synthetic data 210 is computer generated, features to be extracted can be automatically labeled by the computer with superior accuracy as compared to a human labeling real-world data.

In some implementations, synthetic data 210 can be augmented with real world data to enhance its realism. For example, real world noise measurements for a specific region can be recorded, and then injected into the synthetic data generation in order to simulate realistic noise generation.

The machine learning models 212A and 212B receive the seismic imaging data 204 and DAS data 202 respectively and generate a quantified output. For example, once trained the machine learning models 212A and 212B can receive new DAS data 202 and seismic imaging data 204 for a particular region and determine whether a subsurface carbon dioxide reservoir has shifted, and if so, how far it has shifted as well as where it will likely continue to shift to.

In some implementations, the machine learning models 212A and 212B are deep learning models that employ multiple layers of models to generate an output for a received input. A deep neural network is a deep machine learning model that includes an output layer and one or more hidden layers that each apply a non-linear transformation to a received input to generate an output. In some cases, the neural network may be a recurrent neural network. A recurrent neural network is a neural network that receives an input sequence and generates an output sequence from the input sequence. In particular, a recurrent neural network uses some or all of the internal state of the network after processing a previous input in the input sequence to generate an output from the current input in the input sequence. In some other implementations, the machine learning models 212A and 212B are convolutional neural networks. In some implementations, the machine learning models 212A and 212B are an ensemble of models that may include all or a subset of the architectures described above.

In some implementations, the machine learning models 212A and 212B are masked autoencoder (MAE) networks. An autoencoder is an artificial neural network configured to learn efficient codings of unlabeled training data. An autoencoder typically includes an encoder which attempts to encode the input into a reduced dimension encoding, and a decoder which attempts to recreate the input from the encoding. Autoencoders generally can be trained to perform general de-noising applications and efficient compression. A masked autoencoder is trained to predict a portion of the input data that is removed prior to being input. More specifically, during training, a large portion of the input data can be removed (masked) prior to being provided to the encoder. This significantly reduces the input size to the encoder and can allow for a more complex encoder. Mask tokens representing the removed data are then introduced after the input is encoded, prior to being decoded, providing the decoder with positional information and ensuring the final output dimensions match the original input dimensions. In this manner, the decoder output can be compared to the input to allow self-supervised learning on unlabeled data. Following the initial training, classification or feature extraction functionally can be established by providing the MAE with an un-masked input, removing the decoder, and training a classifier (e.g., a multilayer perceptron network) to operate on the encoding. The neural network may include an optimizer for training the network and computing updated layer weights, such as, but not limited to, ADAM, Adagrad, Adadelta, RMSprop, Stochastic Gradient Descent (SGD), or SGD with momentum. In some implementations, the neural network may apply a mathematical transformation, e.g., a convolutional transformation or factor analysis to input data prior to feeding the input data to the network.

As a result, the trained machine learning models 212A and 212B can produce feature labeled imaging data 216A and feature labeled DAS data 216B respectively. The feature labeled data 216A and 216B can include indications of wave arrival (such as seismic or microseismic p P-wave and/or S-wave arrival), faults, subsurface object location, or other subsurface parameters (e.g., density, hygroscopicity, etc.). The feature labeled data 216A and 216B can further include indications of subsurface lithology, rock body identification, river channels, or chimneys.

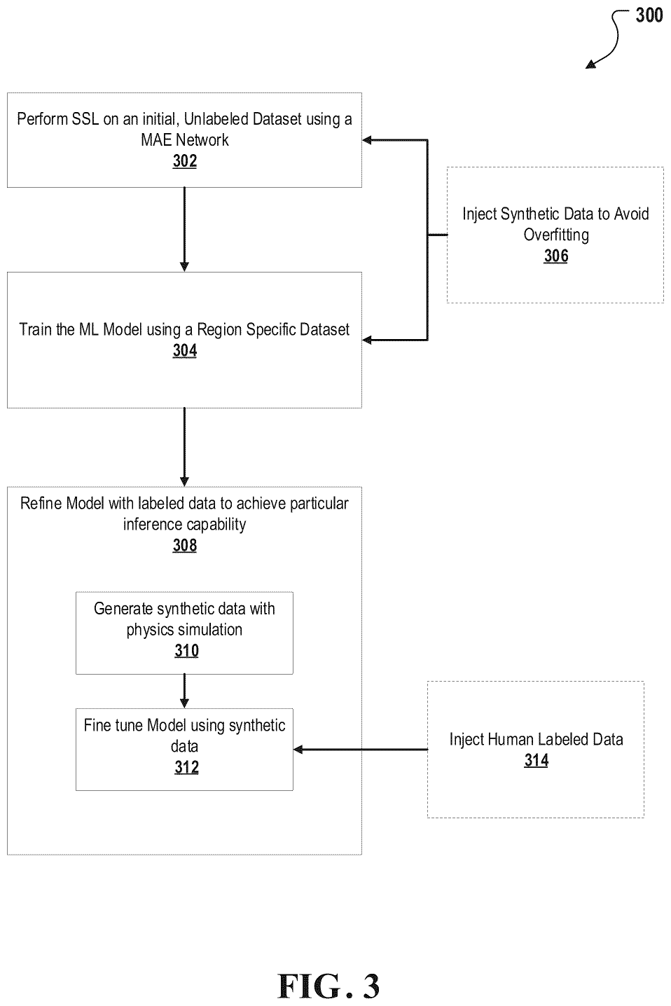

FIG. 3 is a flowchart describing an example method for training a machine learning model to extract features. In some implementations, the example process 300 may be performed using one or more computer-executable programs executed using one or more computing devices.

At 302, self-supervised learning is performed on an initial, unlabeled dataset using a MAE network. The MAE network can include transformers used as encoders and decoders and can have data masked in random or ordered manners. In some implementations, where the input data is two dimensional, the input is masked in rectangles or squares. In some implementations, a random selection of rectangles with randomized dimensions are removed from the input data. In implementations where the input data is three dimensional, random cubes or cuboids can be used to mask the three dimensional input data. The masked data is then encoded by the encoder of the MAE, and following encoding, mask tokens are reintroduced to the encoding for the decoder. The decoder attempts to reproduce the (unmasked) input based on the encoding. This manner of training is advantageous in that it can make use of vase quantities of unlabeled data, which is useful in label sparse fields such as subsurface imaging. While use of a MAE network is described, other self-supervised learning techniques and network architectures are considered within the scope of this disclosure.

At 304, the machine learning model is further trained using a region specific dataset. The region specific dataset can be unlabeled and training performed similarly to 302 above. In some implementations the region specific dataset is collected from a particular geographic region, or includes certain features that are of particular importance to the model being trained.

Optionally, at 306, synthetic data can be introduced into the dataset at 302, 304, or both, and can be used to prevent overfitting in situations where there is a large amount of data recorded from a relatively low number of sources. For example, if a single DAS sensor is used to generate a majority of the data, the MAE network may learn certain traits or attributes that are applicable only to that DAS sensor, and are not specifically associated with the subsurface.

At 308, the pre-trained model is refined using labeled data to achieve particular inference capabilities. For example, the pre-trained model can then be trained to classify data, extract features, or label data. During this portion of training, the machine learning model is no longer provided with masked data, but instead is provided with the full dataset, and optimized using conventional supervised learning techniques as applied to transformer networks and convolutional networks. Additionally the MAE network decoder is replaced with a decoder configured to perform task-specific predictions instead of reconstructing the input as developed in the pre-training. This new decoder can include one or more convolutional layers, fully connected layers, LSTM layers, or transformer layers and use training techniques that result in task-specific capabilities. These techniques can include, but are not limited to, backpropagation, K-fold cross optimization, or ensemble learning. The model can be refined using synthetic data, reducing or eliminating the need for human labeled data.

310 and 312 are illustrated as an example process for refining a pre-trained model in 308. At 310, a physics simulation is used to generate synthetic data. For example, an artificial region including one or more features to be extracted or classified can be generated. Then a simulated DAS survey, or simulated nodal survey can be generated by running a wave propagation physics model simulating both one or more sources (including noise) and receivers (e.g., DAS, or geophones) with receiver induced noise to produce simulated or synthetic data. Similarly, for the artificial region, a velocity model for that region can be convolved with a wavelet, and wave propagation can be simulated throughout the region with a full waveform inversion process performed to generate seismic image data. Because the synthetic data is computer generated, features to be extracted can be automatically labeled by the computer with superior accuracy as compared to a human labeling real-world data.

At 312, the machine learning model is fine-tuned using the generated synthetic data, and optionally (314) human labeled data. An advantage of the significant pre-training performed in 302 and 304 is that the amount of synthetic or human labeled data required to successfully train the model at 312 is reduced. For example, in some implementations the labeled data used in 312 is less than 1% of the amount of data used in 302.

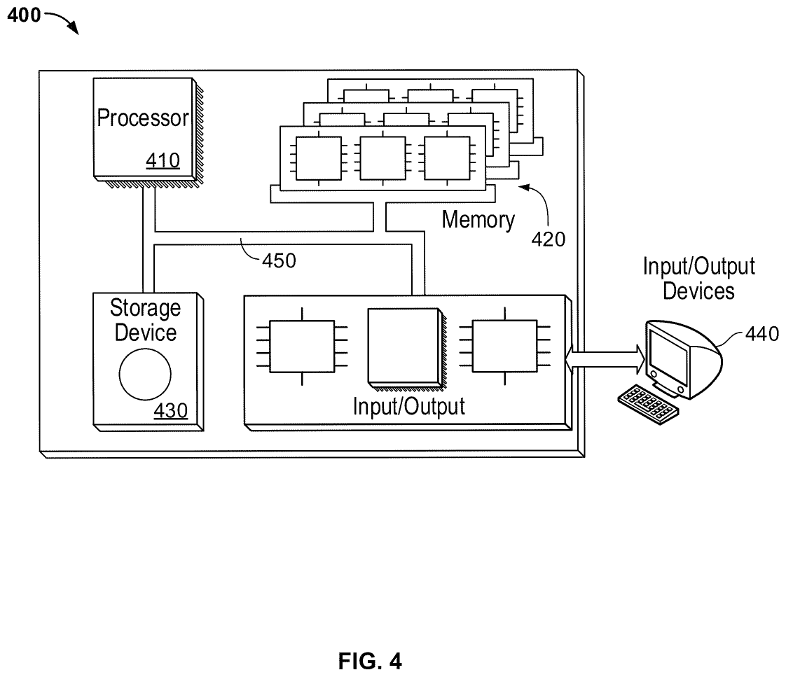

FIG. 4 is a schematic diagram of a computer system 400. The system 400 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., computing system 102) and their structural equivalents, or in combinations of one or more of them. The system 400 is intended to include various forms of digital computers, such as laptops, desktops, workstations, servers, blade servers, mainframes, and other appropriate computers. The system 400 can also include mobile devices, such as personal digital assistants, cellular telephones, smartphones, and other similar computing devices. Additionally, the system can include portable storage media, such as Universal Serial Bus (USB) flash drives. For example, the USB flash drives may store operating systems and other applications. The USB flash drives can include input/output components, such as a wireless transducer or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits). The machine learning model can run on Graphic Processing Units (GPUs) or custom machine learning inference accelerator hardware.

To provide for interaction with a user, the features can be implemented on a computer having a display device such as a CRT (cathode ray tube) or LCD (liquid crystal display) monitor for displaying information to the user and a keyboard and a pointing device, such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations, but is to be accorded the widest scope consistent with the principles and features disclosed herein.

What is claimed is:

1. A method for training a machine learning model, the method comprising:
performing self-supervised learning on a first dataset to initially train the machine learning model;
performing region specific training on the initially trained machine learning model using a second dataset; and
refining the machine learning model using a third dataset to train the machine learning model to perform a particular inference task.

2. The method of claim 1, wherein the first dataset comprises unlabeled data.

3. The method of claim 1, wherein the second dataset is associated with a particular geographic region.

4. The method of claim 1, wherein the third dataset comprises labeled data.

5. The method of claim 1, wherein the third dataset comprises synthetic data.

6. The method of claim 1, wherein the third dataset is less than 10 percent the size of the first dataset.

7. The method of claim 1, comprising generating the synthetic data using a physics based simulation, and wherein the synthetic data is generated to mimic real world regional data.

8. The method of claim 1, wherein the particular inference task comprises wave picking to identify at least one of: a geographic fault; a geographic layer; P-wave arrival; S-wave arrival; de-noising; synthetic data generation; horizon picking; event identification; or a location of a subsurface feature.

9. The method of claim 1, wherein the first, second, and third datasets are distributed acoustic sensing (DAS) datasets.

10. The method of claim 1, wherein the first, second, and third datasets are seismic imaging datasets.

11. The method of claim 1, wherein the first dataset comprises synthetic data.

12. The method of claim 1, wherein the machine learning model is a masked autoencoder network.

13. The method of claim 12, wherein the masked autoencoder network is configured to receive two dimensional input, and wherein the two dimensions comprise time and channel.

14. The method of claim 12, wherein the masked autoencoder network is configured to receive three dimensional input, and wherein the three dimensions comprise time, channel, and frequency.

15. The method of claim 12, wherein training data to the masked autoencoder network is masked in rectangles or cuboids.

16. The method of claim 1, wherein refining the machine learning model using the third dataset comprises performing supervised learning training methods to learn feature extraction on the third dataset.

17. The method of claim 1, wherein region specific training comprises retraining a subset of layers of the machine learning model.

18. A computer system for training a machine learning model, comprising:
one or more processors; and
one or more tangible, non-transitory media operably connectable to the one or more processors and storing instructions that, when executed, cause the one or more processors to perform operations comprising:
performing self-supervised learning on a first dataset to initially train the machine learning model;
performing region specific training on the initially trained machine learning model using a second dataset; and
refining the machine learning model using a third dataset to train the machine learning model to perform a particular inference task.

19. The system of claim 18, wherein the first dataset comprises unlabeled data.

20. The system of claim 18, wherein the second dataset is associated with a particular geographic region.

21. The system of claim 18, wherein the third dataset comprises labeled data.

22. The system of claim 18, wherein the third dataset comprises synthetic data.

23. The system of claim 18, wherein the third dataset is less than 10 percent the size of the first dataset.

24. The system of claim 18, the operations comprising generating the synthetic data using a physics based simulation, and wherein the synthetic data is generated to mimic real world regional data.

25. The system of claim 18, wherein the particular inference task comprises wave picking to identify at least one of: a geographic fault; a geographic layer; P-wave arrival; S-wave arrival; de-noising; synthetic data generation; horizon picking; event identification; or a location of a subsurface feature.

26. The system of claim 18, wherein the first, second, and third datasets are distributed acoustic sensing (DAS) datasets.

27. The system of claim 18, wherein the first, second, and third datasets are seismic imaging datasets.

28. The system of claim 18, wherein the first dataset comprises synthetic data.

29. The system of claim 18, wherein the machine learning model is a masked autoencoder network.

30. The system of claim 29, wherein the masked autoencoder network is configured to receive two dimensional input, and wherein the two dimensions comprise time and channel.

31. The system of claim 29, wherein the masked autoencoder network is configured to receive three dimensional input, and wherein the three dimensions comprise time, channel, and frequency.

32. The system of claim 29, wherein training data to the masked autoencoder network is masked in rectangles or cuboids.

33. The system of claim 18, wherein refining the machine learning model using the third dataset comprises performing supervised learning training methods to learn feature extraction on the third dataset.

34. The system of claim 18, wherein region specific training comprises retraining a subset of layers of the machine learning model.

35. A non-transitory computer readable storage medium storing instructions that, when executed by at least one processor, cause the at least one processor to perform operations for training a machine learning model, the operations comprising:
performing self-supervised learning on a first dataset to initially train the machine learning model;
performing region specific training on the initially trained machine learning model using a second dataset; and
refining the machine learning model using a third dataset to train the machine learning model to perform a particular inference task.
